(19) United States
(12) Patent Application Publication
(10) Pub. No.: US 2025/0309356 A1
(43) Pub. Date: Oct. 2, 2025

(54) METHOD OF MANUFACTURING ALL-SOLID-STATE BATTERY

(71) Applicant: HONDA MOTOR CO., LTD., Tokyo (JP)

(72) Inventor: Kanae Osaki, Wako-shi (JP)

(21) Appl. No.: 19/064,809

(22) Filed: Feb. 27, 2025

(30) Foreign Application Priority Data
Mar. 29, 2024 (JP) 2024-058233

(51) Int. Cl. H01M 10/058; H01M 10/0525

(52) U.S. Cl. CPC H01M 10/058; H01M 10/0525; H01M 2300/0068

(57) ABSTRACT

A method of manufacturing an all-solid-state battery includes a heating process of heating at least an area of an exterior film facing an outermost surface of an electrode laminate in a laminating direction, and an encasing process of encasing the electrode laminate with the exterior film.

### CROSS-REFERENCE TO RELATED APPLICATION

Priority is claimed on Japanese Patent Application No. 2024-058233, filed Mar. 29, 2024, the content of which is incorporated herein by reference.

### BACKGROUND OF THE INVENTION

### Field of the Invention

The present invention relates to a method of manufacturing an all-solid-state battery.

### Description of Related Art

A welding method is used to join a tab lead to an electrode current collector of an electrode laminate contained in an all-solid-state battery. In the joining by the welding, spatter (metallic foreign matter) occurs and may remain on the surface of the electrode current collector as contamination. In addition, when the tab lead is cut, chips are generated and these chips may remain on the surface of the tab lead as contamination. In a state in which the contamination remains on the surface of the electrode current collector, when the surface of the electrode current collector is coated with an exterior film, the exterior film exerts a force that presses the contamination against the surface of the electrode current collector. Then, the contamination may become embedded in the electrode current collector, it can damage the electrode current collector.

As a laminated battery that reduces occurrence of defects during manufacturing due to presence of contamination between the exterior film and the electrode current collector, for example, there is known a structure including an electrode body and a laminated case that encases the electrode body, the laminated case has a multi-layer structure including a sealant layer, a gas barrier layer, an outer layer, and an intermediate layer located between the sealant layer and the gas barrier layer, the gas barrier layer is an aluminum layer, and the intermediate layer contains 5 wt % or more and 50 wt % or less of polyrotaxane (for example, see Japanese Unexamined Patent Application, First Publication No. 2019-125487).

### SUMMARY OF THE INVENTION

However, in the laminated battery disclosed in Japanese Unexamined Patent Application, First Publication No. 2019-125487, although the height of elasticity of the intermediate layer containing a specific amount of polyrotaxane was utilized to suppress corrosion caused by short circuits between an aluminum layer and a negative electrode, when the surface of the electrode current collector was covered with the exterior film, the contamination was embedded in the electrode current collector, and there was a room for improvement for preventing the electrode current collector from being damaged.

An aspect of the present invention is directed to providing a method of manufacturing an all-solid-state battery capable of preventing contamination remaining between an exterior film and an electrode current collector from being embedded in the electrode current collector and the electrode current collector from being destroyed when a surface of the electrode current collector is coated with the exterior film. An aspect of the present invention is directed to contributing to stabilization of battery performance, improvement of quality control in a manufacturing process.

An aspect of the present invention provides the following methods.

(1) A method of manufacturing an all-solid-state battery including:
a heating process of heating at least an area of an exterior film facing an outermost surface of an electrode laminate in a laminating direction; and
an encasing process of encasing the electrode laminate with the exterior film.

Before the exterior film and the electrode laminate come into contact with each other, at least the area of the exterior film facing the outermost surface of the electrode laminate in the laminating direction is softened by heating, which makes it easier for the exterior film to absorb contamination even if contamination is present between the exterior film and the electrode current collector.

(2) The method of manufacturing an all-solid-state battery according to the above-mentioned (1), wherein, in the heating process, a temperature to which the area is heated is a temperature that exceeds a glass transition temperature of a resin that constitutes the area.

By making the temperature of heating the area to a temperature that exceeds the glass transition temperature of the resin constituting the area, it is possible to suppress damage to the electrode laminate due to heating of the exterior film.

(3) The method of manufacturing an all-solid-state battery according to the above-mentioned (1) or (2), wherein the exterior film has a sealant resin layer, a metal layer, and an outer resin layer, and the sealant resin layer, the metal layer, and the outer resin layer are laminated in this sequence.

By using the exterior film having the sealant resin layer, the metal layer, and the outer resin layer, and by softening the sealant resin layer by heating it, even if contamination exists between the exterior film and the electrode current collector, the sealant resin layer becomes more likely to absorb the contamination.

(4) The method of manufacturing an all-solid-state battery according to the above-mentioned (1) or (2), wherein the exterior film has a sealant resin layer, an insulating resin layer, a metal layer, and an outer resin layer, and the sealant resin layer, the insulating resin layer, the metal layer, and the outer resin layer are laminated in sequence.

By using the exterior film having the sealant resin layer, the insulating resin layer, the metal layer, and the outer resin layer, the insulating resin layer can prevent short circuits between the metal layer and the electrode laminate when the electrode laminate is encased in the exterior film. In addition, the exterior film has the insulating resin layer, which provides durability against high load constraints during cycling.

(5) The method of manufacturing an all-solid-state battery according to the above-mentioned (3) or (4), wherein a sealant resin that constitutes the sealant resin layer has a glass transition temperature of less than 45° C.

The glass transition temperature of the sealant resin that constitutes the sealant resin layer is less than 45° C., so that the sealant resin layer is sufficiently softened during the heating process.

(6) The method of manufacturing an all-solid-state battery according to the above-mentioned (4), wherein an insulating resin that constitutes the insulating resin layer has a glass transition temperature that is a temperature that exceeds a glass transition temperature of a sealant layer and has a melting point of 230° C. or higher.

The insulating resin that constitutes the insulating resin layer has the glass transition temperature that exceeds the glass transition temperature of the sealant layer and has a melting point of 230° C. or higher, which prevents the insulating resin layer from softening during the heating process and also prevents short circuits between the metal layer and the electrode laminate.

According to the aspect of the present invention, it is possible to provide a method of manufacturing an all-solid-state battery capable of preventing contamination remaining between an exterior film and an electrode current collector from being embedded in the electrode current collector and the electrode current collector from being destroyed when a surface of the electrode current collector is coated with the exterior film.

### BRIEF DESCRIPTION OF THE DRAWINGS

FIG. 1 is a cross-sectional view showing an exterior film used in a method of manufacturing an all-solid-state battery according to an embodiment of the present invention.

FIG. 2 is a cross-sectional view showing the exterior film used in the method of manufacturing an all-solid-state battery according to the embodiment of the present invention.

### DETAILED DESCRIPTION OF THE INVENTION

Hereinafter, an embodiment of the present invention will be described in detail with reference to the accompanying drawings. Further, the drawings used in the following description may show characteristic parts enlarged for convenience in order to make the features easier to understand, and the dimensional ratios of each component are not limited to those illustrated.

### Method of Manufacturing All-Solid-State Battery

A method of manufacturing an all-solid-state battery of the embodiment has a heating process of heating at least an area of an exterior film facing the outermost surface of an electrode laminate in a laminating direction, and an encasing process of encasing the electrode laminate with the exterior film.

### Electrode Laminate

The electrode laminate in the embodiment has a positive electrode, a negative electrode, and an electrolyte layer.

### Positive Electrode

The positive electrode has a first current collector layer, and a first active material layer containing at least a positive electrode active material, which are laminated. In the embodiment, the positive electrode has a first current collector layer, and first active material layers formed on both main surfaces of the first current collector layer.

The first current collector layer is preferably formed of at least one material with high conductance.

As the material with high conductivity, for example, a metal or alloy containing at least one metal element of silver (Ag), palladium (Pd), gold (Au), platinum (Pt), aluminum (Al), chromium (Cr), and nickel (Ni), or a non-metal of carbon (C) is exemplified. Considering a manufacturing cost as well as high conductivity, aluminum, nickel or stainless steel is preferred. Further, the aluminum does not easily react with the positive electrode active material and electrolyte. For this reason, when the aluminum is used in the first current collector layer, the internal resistance of the battery can be reduced.

The form of the first current collector layer can be, for example, a foil shape, a plate shape, a mesh shape, a non-woven fabric form, a foam form, or the like. In addition, in order to improve adhesion with the first active material layer, carbon or the like may be disposed on the surface of the first current collector layer, or the surface may be roughened.

The first active material layer contains a positive electrode active material that transfers lithium ions and electrons. There are no particular limitations on the positive electrode active material, so long as it can reversibly release and absorb lithium ions and is suitable for electron transportation, and any known positive electrode active material that can be applied to the positive electrode of a lithium ion battery can be used. For example, complex oxides such as lithium cobalt oxide (LiCoO₂), lithium nickel oxide (LiNiO₂), lithium manganese oxide (LiMn₂O₄), solid solution oxides (Li₂MnO₃—LiMO₂ (M=Co, Ni, etc.)), lithium-manganese-nickel-cobalt oxide (LiNiₓMn_{y}Co_{z}O₂, x+y+z=1), olivine-type lithium phosphate oxide (LiFePO₄), and the like; conductive polymers such as polyaniline, polypyrrole, and the like; sulfides such as Li₂S, CuS, Li—Cu—S compounds, TiS₂, FeS, MoS₂, and Li—Mo—S compounds; and mixtures of sulfur and carbon are exemplified. The positive electrode active material may be composed of one of the above materials alone or two or more of them.

The first active material layer contains a positive electrode active material and an electrolyte that transfers lithium ions. There are no particular limitations on the electrolyte as long as it has lithium ion conductivity, and any material generally used for lithium ion batteries can be used. As the electrolyte, for example, inorganic solid electrolytes such as a sulfide solid electrolyte material, an oxide solid electrolyte material, a halide solid electrolyte, lithium-containing salts, and the like, polymer-based solid electrolytes such as polyethylene oxide and the like, gel-based solid electrolytes such as lithium-containing salts or ionic liquids with lithium ion conductivity, or the like, can be exemplified. Among these, sulfide solid electrolyte materials are preferred from the viewpoints of the high conductivity properties of lithium ions, as well as favorable structural formability or interface bonding by pressing.

The electrolyte may be composed of one of the above materials alone, or may be composed of two or more of them. The electrolyte contained in the first active material layer may be the same material as the electrolyte contained in the second active material layer or the solid electrolyte layer, or it may be a different material.

The first active material layer may contain a conductive additive from the viewpoint of improving the conductivity of the positive electrode. As the conductive additive, any conductive additive that can be used in lithium ion batteries can be used. For example, carbon black such as acetylene black, ketjen black, or the like; carbon fiber; vapor grown carbon fiber; graphite powder; and a carbon material such as carbon nanotubes or the like can be exemplified. The conductive additive may be composed of one of the above materials alone, or two or more of them.

In addition, the first active material layer may contain the positive electrode active materials, and a binder that serves to bind the positive electrode active material and the first current collector layer.

The first active material layer may be formed on both main surfaces of the first current collector layer or may be formed on only one main surface of the first current collector layer. In addition, when the positive electrode is a single-sided coated electrode, a laminated positive electrode with two positive electrodes laminated to align their current collector surfaces may be used as a double-sided coated electrode. In addition, when the first current collector layer has a three-dimensional porous structure such as a mesh form, a non-woven fabric form, a foam form, etc., the first current collector layer may be provided integrally with the first active material layer.

The first current collector layer is assembled at one end portion of the all-solid-state battery in the widthwise direction.

Since the first active material layer is in contact with the electrolyte layer, it may contain sulfide contained in the electrolyte layer.

### Negative Electrode

The negative electrode has the second active material layer that contains at least a negative electrode active material.

The second current collector layer contains, for example, copper (Cu). The second current collector layer, like the first current collector layer, may contain a material other than copper that has high conductance. The materials other than copper that have high conductivity include, for example, metals or alloys that contain at least one of metal elements of silver (Ag), palladium (Pd), gold (Au), platinum (Pt), chromium (Cr) and nickel (Ni), or non-metals such as carbon (C). Considering the manufacturing cost as well as the conductivity height, nickel or stainless steel is preferable as a material other than copper. Further, the stainless steel does not react easily with the positive electrode active material, the negative electrode active material and the electrolyte. For this reason, using stainless steel for the second current collector layer can reduce the manufacturing costs of the battery.

The form of the second current collector layer can be, for example, a foil form, a plate form, a mesh form, a non-woven fabric form, a foam form, etc. In addition, in order to improve adhesion with the second active material layer, carbon or the like may be disposed on the surface of the second current collector layer, or the surface may be roughened.

The second active material layer contains a negative electrode active material that transfers lithium ions and electrons. There are no particular limitations on the negative electrode active material, as long as it can reversibly release and absorb lithium ions and is suitable for electron transportation, and any known negative electrode active material that can be applied to the negative electrode of the lithium ion battery can be used. For example, a carbon material such as natural graphite, artificial graphite, resin charcoal, carbon fiber, activated charcoal, hard carbon, soft carbon, or the like; an alloy-based material mainly made of tin, tin alloy, silicon, silicon alloy, gallium, gallium alloy, indium, indium alloy, aluminum, aluminum alloy, or the like; a conductive polymer such as polyacene, polyacetylene, polypyrrole, or the like; metal lithium; and a lithium alloy such as lithium titanium composite oxide (for example, Li₄Ti₅O₁₂) or the like are exemplified. These negative electrode active materials may be composed of one of the above materials alone, or may be composed of two or more of them.

The second active material layer contains the negative electrode active material, and an electrolyte that transfers lithium ions. There are no particular limitations on the electrolyte as long as it has lithium ion conductivity, and any material generally used for lithium ion batteries can be used. As the electrolyte, for example, an inorganic solid electrolyte such as a sulfide solid electrolyte material, an oxide solid electrolyte material, a halide solid electrolyte, lithium-containing salts, or the like, a polymer-based solid electrolyte such as polyethylene oxide or the like, a gel-based solid electrolyte containing lithium-containing salts or ion liquid with lithium ion conductivity, or the like, can be exemplified. The electrolyte may be composed of one of the above materials alone, or may be composed of two or more of them.

The electrolyte contained in the second active material layer may be the same as or different from the electrolyte contained in the first active material layer or the solid electrolyte layer.

The second active material layer may contain conductive additives and binders. There are no particular limitations on these materials, but for example, materials similar to those used for the first active material layer described above can be used.

The second active material layer may be formed on both main surfaces of the second current collector layer, or may be formed on only one main surface of the second current collector layer. In addition, when the second current collector layer has a three-dimensional porous structure such as a mesh form, a non-woven fabric form, a foam form, etc., the second current collector layer may be provided integrally with the second active material layer.

### Electrolyte Layer

The electrolyte layer is disposed between the first active material layer and the second active material layer.

There are no particular limitations on the electrolyte as long as it has lithium ion conductivity and insulating properties, and any material generally used for lithium ion batteries can be used. For example, an inorganic solid electrolyte such as a sulfide solid electrolyte material, an oxide solid electrolyte material, a halide solid electrolyte, a lithium-containing salts, or the like, a polymer-based solid electrolyte such as polyethylene oxide, or the like, a gel-based electrolyte containing lithium-containing salts or ion liquid with lithium ion conductivity, or the like, can be exemplified. Among these, sulfide solid electrolyte materials are preferred from the viewpoints of the high conductive properties of lithium ions, as well as favorable structural formability and interface bonding by pressing.

The form of the electrolyte material is not particularly limited, but may be, for example, in the form of particles.

The electrolyte layer may contain an adhesive to impart mechanical strength and flexibility.

The electrolyte layer may be in the form of a sheet having a porous substrate and a solid electrolyte held on the porous substrate. The form of the porous substrate is not particularly limited, and examples include woven fabric, non-woven fabric, mesh cloth, porous membrane, expanded sheet, punched sheet, etc. Among these forms, the non-woven fabric is preferred from the viewpoint of handling, which allows a higher loading amount of the solid electrolyte to be achieved.

The porous substrate is preferably composed of an insulating material. Accordingly, it is possible to improve insulation properties of the electrolyte layer. As the insulating material, for example, nylon, polyester, polyethylene, polypropylene, polytetrafluoroethylene, ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, resin materials such as acrylic resin or the like; natural fibers such as hemp, wood pulp, and cotton linters, glass, and the like, are exemplified.

### Heating Process

In the heating process, at least an area of the exterior film, which covers the surface of the electrode laminate and which encases the electrode laminate, facing the outermost surface of the electrode laminate in the laminating direction is heated. Even if contamination is present on the outermost surface of the electrode laminate, since the heating softens at least the area of the exterior film facing the outermost surface in the laminating direction of the electrode laminate, when the exterior film exerts a force pressing the contamination against the outermost surface of the electrode current collector, the contamination is prevented from being embedded in the exterior film and destroying the electrode current collector.

In the heating process, the temperature at which the area is heated is preferably, for example, 45° C. or higher and lower than 80° C. If the temperature at which the area is heated exceeds a glass transition temperature of the resin that constitutes the area, the area softens, and when the exterior film exerts a force pressing the contamination against the outermost surface of the electrode current collector, the contamination is embedded in the exterior film. Further, the temperature at which the area is heated may be 45° C. or higher, or 60° C. or higher.

When a first or second embodiment described later is used as the exterior film, the area to be heated in the heating process is a sealant resin layer.

### Exterior Film

The exterior film used in the method of manufacturing an all-solid-state battery of the embodiment will be described.

### First Embodiment

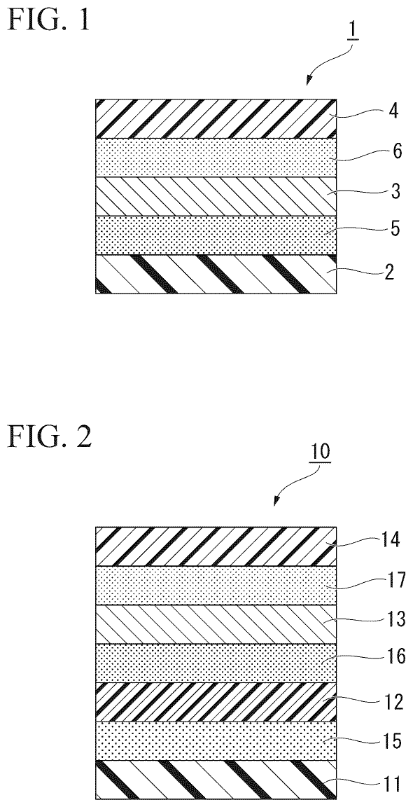

FIG. 1 is a cross-sectional view showing a first embodiment of an exterior film used in a method of manufacturing an all-solid-state battery of the embodiment.

As shown in FIG. 1, an exterior film 1 has a sealant resin layer 2, a metal layer 3, and an outer resin layer 4. The sealant resin layer 2, the metal layer 3, and the outer resin layer 4 are laminated in sequence. The sealant resin layer 2 and the metal layer 3 are laminated via a first adhesive layer 5. The metal layer 3 and the outer resin layer 4 are laminated via a second adhesive layer 6. The sealant resin layer 2 is an area facing the outermost surface of the electrode laminate in the laminating direction. Accordingly, in the method of manufacturing an all-solid-state battery of the embodiment, at least the sealant resin layer 2 is heated and softened.

A sealant resin constituting the sealant resin layer 2 preferably has a glass transition temperature of, for example, less than 45° C. A melting point of the sealant resin constituting the sealant resin layer 2 is preferably, for example, 130° C. or higher. The glass transition temperature and the melting point of the sealant resin are set within the range, and the sealant resin layer 2 can be softened sufficiently by heating it at a temperature above the glass transition temperature and below the melting point.

As the sealant resin, for example, one with a Rockwell hardness of less than 85 is preferable.

Examples of the sealant resin include modified polypropylene, polyethylene, and the like.

A thickness of the sealant resin layer 2 is preferably equal to or greater than 10 μm and equal to or smaller than 80 μm, or preferably equal to or greater than 10 μm and equal to or smaller than 40 μm. When the thickness of the sealant resin layer 2 is equal to or greater than the lower limit value, in a case in which the diameter (particle size) of the contamination is equal to or greater than 10 μm, the contamination can be absorbed within the sealant resin layer 2. When the thickness of the sealant resin layer 2 is equal to or smaller than the upper limit value, it is possible to prevent the sealant resin layer 2 from becoming thicker.

The metal constituting the metal layer 3 may be, for example, aluminum.

The thickness of the metal layer 3 is preferably equal to or greater than 20 μm and equal to or smaller than 120 μm, and more preferably equal to or greater than 40 μm and equal to or smaller than 80 μm.

Examples of the resin that constitutes the outer resin layer 4 include polyesters such as polyethylene terephthalate or the like.

An adhesive agent that constitutes the first adhesive layer 5 and the second adhesive layer 6 includes, for example, epoxy resin, urethane resin, or the like.

The thickness of the first adhesive layer 5 and the second adhesive layer 6 is preferably equal to or greater than 1 μm and equal to smaller than 3 μm.

### Second Embodiment

FIG. 2 is a cross-sectional view showing a second embodiment of an exterior film used in the method of manufacturing an all-solid-state battery of the embodiment.

As shown in FIG. 2, an exterior film 10 has a sealant resin layer 11, an insulating resin layer 12, a metal layer 13, and an outer resin layer 14. The sealant resin layer 11, the insulating resin layer 12, the metal layer 13, and the outer resin layer 14 are laminated in sequence. The sealant resin layer 11 and the insulating resin layer 12 are laminated via a first adhesive layer 15. The insulating resin layer 12 and the metal layer 13 are laminated via a second adhesive layer 16. The metal layer 13 and the outer resin layer 14 are laminated via a third adhesive layer 17. The sealant resin layer 11 is an area facing the outermost surface of the exterior film 10 in the laminating direction. Accordingly, in the method of manufacturing an all-solid-state battery of the embodiment, at least the sealant resin layer 11 is heated and softened.

The sealant resin that constitutes the sealant resin layer 11 is the same as the sealant resin that constitutes the sealant resin layer 2.

A thickness of the sealant resin layer 11 is equal to the thickness of the sealant resin layer 2.

It is preferable that the resin constituting the insulating resin layer 12 has a glass transition temperature that exceeds the glass transition temperature of the sealant layer and a melting point of 230° C. or higher. By setting the glass transition temperature and melting point of the resin that constitutes the insulating resin layer 12 within the range, softening of the insulating resin layer 12 is prevented by heating the above-mentioned area.

As the resin that constitutes the insulating resin layer 12, for example, polyethylene terephthalate, reinforced polypropylene containing fibers such as glass fibers, reinforced polyester containing fibers such as glass fibers, polyimide, polybenzimidazole, and the like, are exemplified.

A thickness of the insulating resin layer 12 is appropriately adjusted according to the resin that constitutes the insulating resin layer 12.

The metal that constitutes the metal layer 13 is the same as the metal that constitutes the metal layer 3.

A thickness of the metal layer 13 is the same as the thickness of the metal layer 3.

The resin that constitutes the outer resin layer 14 is the same as the resin that constitutes the outer resin layer 4.

A thickness of the outer resin layer 14 is the same as the thickness of the outer resin layer 4.

The adhesive agent that constitutes the first adhesive layer 15, the second adhesive layer 16 and the third adhesive layer 17 is the same as the adhesive agent that constitutes the first adhesive layer 5 and the second adhesive layer 6. The adhesive agent that constitutes the first adhesive layer 15, the adhesive agent that constitutes the second adhesive layer 16, and the adhesive agent that constitutes the third adhesive layer 17 may all be different, or the two may be the same, or they may all be the same.

The thickness of the first adhesive layer 15, the second adhesive layer 16 and the third adhesive layer 17 is equal to the thickness of the first adhesive layer 5 and the second adhesive layer 6.

### Encasing Process

In the encasing process, the electrode laminate is encased in the exterior film in which at least the area facing the outermost surface of the electrode laminate in the laminating direction has been heated during the heating process.

That is, in the encasing process, the electrode laminate is covered and surrounded by the exterior film so that at least the heated area is in contact with the outermost surface of the electrode laminate in the laminating direction.

Through the above process, the all-solid-state battery constituted by the electrode laminate and the exterior film configured to encase the electrode laminate is obtained.

According to the method of manufacturing an all-solid-state battery of the embodiment, before the exterior film and the electrode laminate come into contact with each other, at least the area of the exterior film facing the outermost surface of the electrode laminate in the laminating direction is softened by heating, which makes it easier for the exterior film to absorb contamination even if the contamination is present between the exterior film and the electrode current collector.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A method of manufacturing an all-solid-state battery comprising:
a heating process of heating at least an area of an exterior film facing an outermost surface of an electrode laminate in a laminating direction; and
an encasing process of encasing the electrode laminate with the exterior film.

2. The method of manufacturing an all-solid-state battery according to claim 1, wherein, in the heating process, a temperature at which the area is heated is a temperature that exceeds a glass transition temperature of a resin that constitutes the area.

3. The method of manufacturing an all-solid-state battery according to claim 1, wherein the exterior film has a sealant resin layer, a metal layer, and an outer resin layer, and
the sealant resin layer, the metal layer, and the outer resin layer are laminated in sequence.

4. The method of manufacturing an all-solid-state battery according to claim 1, wherein the exterior film has a sealant resin layer, an insulating resin layer, a metal layer, and an outer resin layer, and
the sealant resin layer, the insulating resin layer, the metal layer, and the outer resin layer are laminated in sequence.

5. The method of manufacturing an all-solid-state battery according to claim 3, wherein a sealant resin that constitutes the sealant resin layer has a glass transition temperature of less than 45° C.

6. The method of manufacturing an all-solid-state battery according to claim 4, wherein an insulating resin that constitutes the insulating resin layer has a glass transition temperature that is a temperature that exceeds a glass transition temperature of a sealant layer and has a melting point of 230° C. or higher.
